(19) United States
(12) Patent Application Publication
(10) Pub. No.: US 2026/0298327 A1
(43) Pub. Date: Oct. 1, 2026

(54) SHIFT APPARATUS

(71) Applicants: TOYOTA JIDOSHA KABUSHIKI KAISHA, Toyota-shi (JP); AISIN CORPORATION, Kariya-shi (JP)

(72) Inventors: Taihei WAKAMATSU, Toyota-shi (JP); Masashi SASAKI, Seto-shi (JP); Yoshihiro MIZUNO, Nagoya-shi (JP); Toshiya YAMASHITA, Toyota-shi (JP); Shinya KUWAHARA, Kariya-shi (JP)

(73) Assignees: TOYOTA JIDOSHA KABUSHIKI KAISHA, Toyota-shi (JP); AISIN CORPORATION, Kariya-shi (JP)

(21) Appl. No.: 19/635,279

(22) Filed: Mar. 31, 2026

(30) Foreign Application Priority Data
Apr. 1, 2025 (JP) 2025-060863

(51) Int. Cl. F16H 57/00; F16H 21/24

(52) U.S. Cl. CPC F16H 57/0006; F16H 21/24

(57) ABSTRACT

A shift apparatus includes a motor and a swing-type slider crank mechanism that decelerates rotation of the motor, the shift apparatus selectively switching an operating state of a parking lock device between a locked state and an unlocked state, wherein the swing-type slider crank mechanism includes a short lever and a long lever, and wherein, when the swing-type slider crank mechanism is in a predetermined state, the operating state of the parking lock device is switched to the unlocked state, and a predetermined take-up of play is performed to suppress relative movement between the short lever and the long lever in order to suppress rattling noise between the short lever and the long lever.

This application claims priority from Japanese Patent Application No. 2025-060863 filed on Apr. 1, 2025, the disclosure of which is herein incorporated by reference in its entirety.

### FIELD OF THE INVENTION

The present invention relates to a shift apparatus having a motor and a swing-type slider-crank mechanism that decelerates the rotation of the motor, the shift apparatus selectively switching the operating state of a parking lock device between a locked state and an unlocked state.

### BACKGROUND OF THE INVENTION

A shift apparatus is known that selectively switch the operating state of a parking lock device between a locked state and an unlocked state. An example of such a device is disclosed in Patent Document 1. The “locked state” is a state in which the parking lock device prevents rotation of a parking gear that rotates in conjunction with a pair of drive wheels. On the other hand, the “unlocked state” is a state in which the parking lock device is released from the locked state and allows rotation of the parking gear that rotates in conjunction with the pair of drive wheels.

### PRIOR ART DOCUMENT

### Patent Document

[Patent Document 1] JP2014-025581A

### SUMMARY OF THE INVENTION

Patent Document 1 discloses a shift apparatus having a swing-type slider-crank mechanism. The swing-type slider-crank mechanism includes a short lever with a rotating pin and a swinging long lever with a substantially rectangular, elongated slot for locking the pin. To allow the long lever of the swing-type slider-crank mechanism to swing, a predetermined amount of clearance, i.e., play is required between the inner wall surface of the elongated slot and the outer peripheral surface of the pin. For example, when the shift apparatus is controlled such that the parking lock device is in the unlocked state, external vibrations input to the shift apparatus may act on the clearance of the swing-type slider-crank mechanism, potentially causing rattling noise.

The present invention has been made in view of the above circumstances, and aims to provide a shift apparatus capable of suppressing rattling noise from the swing-type slider-crank mechanism.

According to the present invention, there is provided a shift apparatus includes a motor and a swing-type slider crank mechanism that decelerates rotation of the motor, the shift apparatus selectively switching an operating state of a parking lock device between a locked state and an unlocked state, wherein (a) the swing-type slider crank mechanism includes a short lever and a long lever, and wherein, (b) when the swing-type slider crank mechanism is in a predetermined state, the operating state of the parking lock device is switched to the unlocked state, and a predetermined take-up of play is performed to suppress relative movement between the short lever and the long lever in order to suppress rattling noise between the short lever and the long lever.

In the shift apparatus according to the present invention, (a) the swing-type slider crank mechanism includes a short lever and a long lever, and, (b) when the swing-type slider crank mechanism is in a predetermined state, the operating state of the parking lock device is switched to the unlocked state, and a predetermined take-up of play is performed to suppress relative movement between the short lever and the long lever in order to suppress rattling noise between the short lever and the long lever. Accordingly, when the operating state of the parking lock device is switched to the unlocked state, a predetermined take-up of play is performed to suppress relative movement between the short lever and the long lever. As a result, even if external vibrations are input to the shift apparatus, rattling noise caused by the play in the swing-type slider-crank mechanism is suppressed.

### BRIEF DESCRIPTION OF THE DRAWINGS

FIG. 1 is a schematic configuration diagram of a vehicle mounted with a shift apparatus including a swing-type slider-crank mechanism according to a first embodiment.

FIG. 2 is an explanatory diagram of the parking lock device shown in FIG. 1.

FIGS. 3A to 3D are explanatory diagrams of the swing-type slider-crank mechanism shown in FIG. 1.

FIGS. 4A and 4B are explanatory diagrams of a swing-type slider-crank mechanism according to a second embodiment.

FIGS. 5A to 5D are explanatory diagrams of a swing-type slider-crank mechanism according to a third embodiment.

FIGS. 6A to 6F are explanatory diagrams of a swing-type slider-crank mechanism according to a fourth embodiment.

FIGS. 7A and 7B are explanatory diagrams of a swing-type slider-crank mechanism 430 (hereinafter referred to simply as “crank mechanism 430”) according to fifth and sixth embodiments.

### DETAILED DESCRIPTION OF PREFERRED EMBODIMENT

Embodiments of the present invention will now be described in detail with reference to the drawings. Note that in the embodiments, the drawings have been appropriately simplified or modified, and the dimensional ratios, shapes, etc. of parts are not necessarily accurately depicted. Furthermore, in the embodiments, if the configuration is substantially the same as the preceding embodiment, the description will focus on the differences, and parts that are substantially common in function to the preceding embodiment will be assigned the same reference numerals and the description thereof will be omitted as appropriate.

### First Embodiment

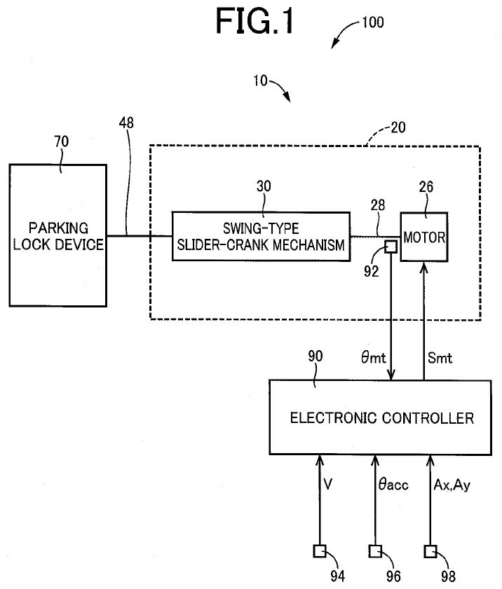

FIG. 1 is a schematic configuration diagram of a vehicle 100 mounted with a shift apparatus 10 including a swing-type slider-crank mechanism 30 (hereinafter referred to simply as “crank mechanism 30”) according to a first embodiment. The shift apparatus 10 is a shift-by-wire system. The shift apparatus 10 includes a motor 26, the crank mechanism 30, and an electronic controller 90. The motor 26 and the crank mechanism 30 constitute an actuator 20. The shift apparatus 10 is an apparatus that is mounted on the vehicle 100 and switches the shift range of the vehicle 100. The operation of selecting the shift range of the vehicle 100 is performed, for example, by the driver operating a well-known shift lever. The shift apparatus 10 switches the shift range by the rotation of the motor 26. The shift range represents the state of power transmission from a driving power source (e.g., an engine or a driving motor) to a pair of drive wheels in the vehicle 100. For example, the shift apparatus 10 switches the shift range from one of P range and non-P range to the other. The P range is a parking range in which the vehicle 100 is placed in a neutral state and a pair of drive wheels are mechanically fixed so as to be non-rotatable. The non-P range is a shift range other than the P range, such as a reverse-travel range that enables the vehicle 100 to travel in reverse, a neutral range that sets the vehicle to a neutral state in which power transmission from the driving power source to the pair of drive wheels is cut off, and a forward-travel range that enables the vehicle 100 to travel forward.

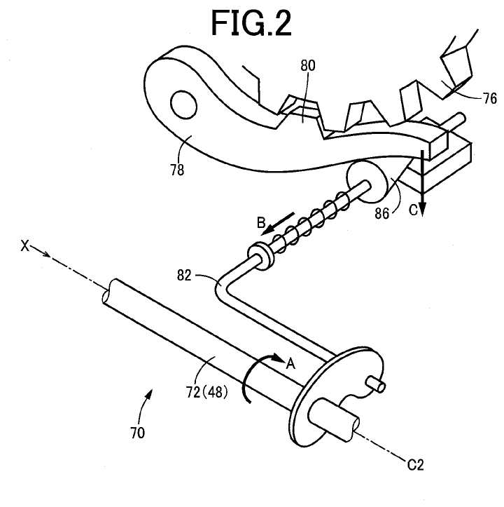

The motor 26 is, for example, a well-known DC electric motor. The motor 26 is, for example, a motor that generates a reluctance torque Tᵣₑₗ [N·m] when the motor is not driven. For example, the motor is a permanent-magnet type DC commutator motor. The reluctance torque Tᵣₑₗ is a well-known torque that rotates the rotor of the motor 26 so that the magnetic field lines take the shortest magnetic path, and is a torque generated based on the same principle as cogging torque. The rotation of the motor 26 is transmitted, in order from the motor 26 side, through a motor output shaft 28, which is the output shaft of the motor 26, and a crank mechanism 30, and is output from a crank output shaft 48. The crank output shaft 48 is the output shaft of the actuator 20. The crank output shaft 48 is coupled to a manual shaft 72 so as to be non-rotatable relative to each other (see FIG. 2). Rotation of the crank output shaft 48 switches the operating state of a parking lock device 70 to change the shift range. Details of the crank mechanism 30 will be described later.

The electronic controller 90 is configured including, for example, a so-called microcomputer and performs signal processing according to a pre-stored program. The electronic controller 90 controls the rotation of the motor 26 to switch the shift range. The electronic controller 90 receives various signals (e.g., a motor rotation angle θₘₜ [deg] indicating the rotational position of the motor output shaft 28, a vehicle speed V [km/h], an accelerator opening θ_{acc} [%] that is the amount of accelerator operation representing the magnitude of driver's acceleration operation, and a longitudinal acceleration Aₓ [m/s²] and a lateral acceleration A_{y} [m/s²] of the vehicle 100) based on detected values from various sensors (e.g., a rotation angle sensor 92, a vehicle speed sensor 94, an accelerator opening sensor 96, an acceleration sensor 98, etc.). The electronic controller 90 outputs to the motor 26 a motor control signal Sₘₜ to control the rotation of the motor 26.

FIG. 2 is an explanatory diagram of the parking lock device 70 shown in FIG. 1. The parking lock device 70 includes the manual shaft 72, a parking gear 76, a parking lock pawl 78, a parking rod 82, and a tapered member 86. The parking lock device 70 is a well-known device that, when the driver operates the shift range of the vehicle 100 to the P range, renders the parking gear 76 non-rotatable, thereby preventing the rotation of the pair of drive wheels coupled to the parking gear 76. FIG. 2 shows the parking lock device 70 in its locked operating state. When the manual shaft 72 is rotated in the direction of arrow A in the locked state, one end of the parking rod 82 is moved in the direction of arrow B, and the resultant movement of the tapered member 86 moves a claw 80 of the parking lock pawl 78 in the direction of arrow C. This switches the parking lock device 70 to its unlocked operating state. When the manual shaft 72 is rotated in the direction opposite to the arrow A in the unlocked state, one end of the parking rod 82 is moved in the direction opposite to the arrow B, and the resultant movement of the tapered member 86 moves the claw 80 in the direction opposite to the arrow C. This switches the parking gear 76 to its locked operating state. For example, when the driver operates the shift range to the non-P range, the rotation of the motor 26 rotates the manual shaft 72, switching the parking lock device 70 to its unlocked state. The shift apparatus 10 is a device that selectively switches the operating state of the parking lock device 70 to either the locked state or the unlocked state.

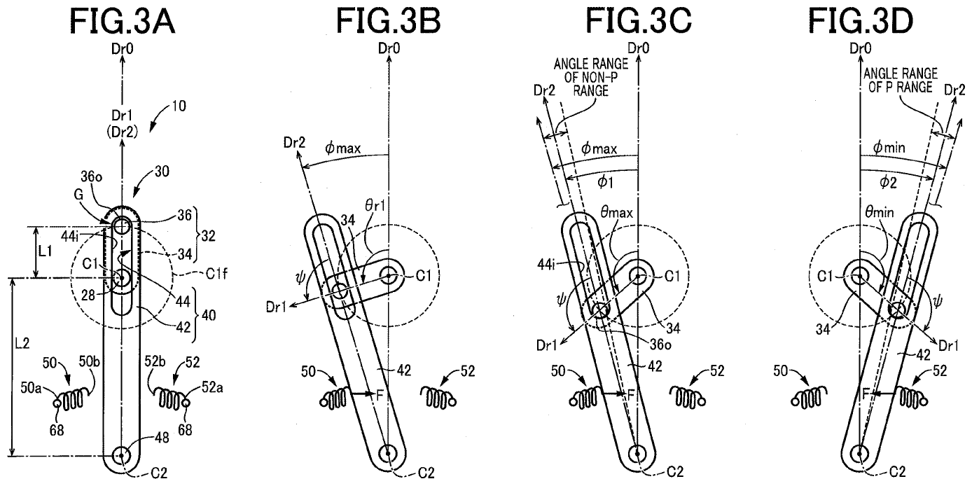

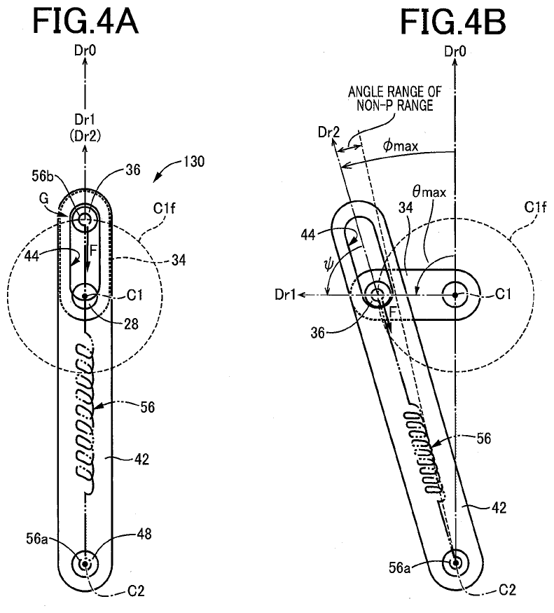

FIGS. 3A to 3D are explanatory diagrams of the crank mechanism 30 shown in FIG. 1. FIGS. 3A to 3D (and also FIGS. 4A to 7B described below) are views of the crank mechanism 30 as seen in the direction of arrow X shown in FIG. 2.

The crank mechanism 30 includes a short lever 32 and a long lever 40.

One end of a main body 34 of the short lever 32 is fixedly secured to the motor output shaft 28 so as to be non-rotatable relative thereto. The rotational centerline of the motor output shaft 28 and the short lever 32 is a first axis C1. A cylindrical pin 36 extending in the direction of the first axis C1 is disposed at the other end of the main body 34. The pin 36 rotates along an arc of a circle C1f centered on the first axis C1. One end of a main body 42 of the long lever 40 is fixedly secured to the crank output shaft 48 so as to be non-rotatable relative thereto. The rotational centerline of the crank output shaft 48 and the long lever 40 is a second axis C2. A substantially rectangular, elongated slot 44 extending in the longitudinal direction of the main body 42 is disposed at the other end of the main body 42. The pin 36 is slidable within the elongated slot 44. A play G is disposed between an inner wall surface 44i of the elongated slot 44 and an outer peripheral surface 36o of the pin 36. The play G includes a peripheral clearance centered on the second axis C2. The inner wall surface 44i and the outer peripheral surface 36o are surfaces that face each other in a plane perpendicular to the first axis C1. The long lever 40 functions as a speed reducer that slows down the rotation of the short lever 32.

In FIGS. 3A to 3D (as well as FIGS. 4A to 7B described below), the rotation angle of the main body 34 of the short lever 32 will be referred to as “rotation angle θ”, and the rotation angle of the main body 42 of the long lever 40 will be referred to as the “rotation angle φ”. For the rotation angles θ and φ, an angle in the counterclockwise direction, i.e., toward the non-P range state, from the reference direction Dᵣ₀ is defined as positive, and an angle in the clockwise direction is defined as negative. The rotation angle of the indicated direction Dᵣ₁ relative to the indicated direction Dᵣ₂ is referred to as an intersection angle ψ [deg]. The intersection angle ψ is defined as positive when the indicated direction Dᵣ₁ rotates counterclockwise relative to the indicated direction Dᵣ₂, and negative when the indicated direction Dᵣ₁ rotates clockwise. When the indicated direction Dᵣ₁ and the indicated direction Dᵣ₂ are identical, the intersection angle ψ is 0 degrees. The length from the first axis C1 to the center of the pin 36 is L₁ [m], and the length from the second axis C2 to the first axis C1 is L₂ [m].

FIG. 3A shows a state in which the intersection angle ψ is 0 degrees. FIG. 3B shows a state in which the indicated direction Dᵣ₂ has rotated counterclockwise to its maximum, resulting in an intersection angle ψ of 90 degrees, where the rotation angle φ [deg] is a maximum rotation angle φₘₐₓ, and the rotation angle θ [deg] is a rotation angle θᵣ₁ forming the right-angle intersection, i.e., a right-angle intersection rotation angle θᵣ₁. FIG. 3C shows a state in which the short lever 32 has further rotated counterclockwise from the state shown in FIG. 3B, resulting in an intersection angle ψ exceeding 90 degrees, where the rotation angle φ is a return position rotation angle φₗ (0<φₗ<φₘₐₓ), and the rotation angle θ is a maximum rotation angle θₘₐₓ (180>θₘₐₓ>θᵣ₁). FIG. 3C shows the non-P range state of the crank mechanism 30. The crank mechanism 30 is in a non-P range when, for example, the rotation angle φ is within a predetermined angle range that includes the return position rotation angle φₗ. The “non-P range state” refers to the state of the shift apparatus 10, i.e., the state of the crank mechanism 30 rendering the parking lock device 70 unlocked. In the crank mechanism 30, the elongated slot 44 and the pin 36 are engaged so that the absolute value of the intersection angle ψ exceeds 90 degrees. The non-P range state corresponds to the “predetermined state” in the present invention.

Although not shown in FIG. 3, when the short lever 32 rotates clockwise and the intersection angle ψ is −90 degrees, the rotation angle φ is a minimum rotation angle φₘᵢₙ, and the rotation angle θ is a right-angle intersection rotation angle θᵣ₂. FIG. 3D shows a state in which the short lever 32 further rotates clockwise after the indicated direction Dᵣ₂ has rotated to its maximum in the clockwise direction, where the rotation angle φ is a return position rotation angle φ₂ (0>φ₂>φₘᵢₙ), and the rotation angle θ is a minimum rotation angle θₘᵢₙ(−180<θₘᵢₙ<θᵣ₂). FIG. 3D shows the P range state of the crank mechanism 30. The crank mechanism 30 is in the P range state when the rotation angle φ is within a predetermined angle range that includes the return position rotation angle φ₂. The “P range state” refers to the state of the shift apparatus 10, i.e., the state of the crank mechanism 30 rendering the parking lock device 70 locked.

The crank mechanism 30 includes a compression coil spring 50 that biases the main body 42, as shown in FIGS. 3B and 3C. One end 50a of the compression coil spring 50 is coupled to a non-rotating member 68, and the other end 50b is in contact with the main body 42 in FIGS. 3B and 3C, biasing the long lever 40 to rotate clockwise. In FIG. 3C, the intersection angle ψ is greater than 90 degrees but less than 180 degrees, and the biasing force F [N] of the compression coil spring 50 presses the inner wall surface 44i against the outer peripheral surface 36o in the clockwise direction, thereby taking up the play G [m]. The intersection angle ψ being less than 180 degrees means that the short lever 32 cannot rotate 360 degrees. This take-up of play restricts relative movement between the short lever 32 and the long lever 40, and corresponds to the “predetermined take-up of play” in the present invention. The biasing force F is a torque that rotates the short lever 32 counterclockwise. The biasing force F is set to a magnitude that allows the motor 26 to rotate the short lever 32 against the biasing force F and also allows for the suppression of rattling noise. The “rattling noise” is a collision noise that occurs when the outer peripheral surface 36o and the inner wall surface 44i collide with each other at the play G. The compression coil spring 50 corresponds to the “biasing member” in the present invention. In FIG. 3D, the crank mechanism 30 includes a compression coil spring 52 that is in contact with the main body 42 and biases the long lever 40 to rotate counterclockwise. Similarly, in FIG. 3D, the biasing force F of the compression coil spring 52 presses the inner wall surface 44i against the outer peripheral surface 36o in the counterclockwise direction, thereby achieving a take-up of play.

According to this embodiment, (a) the crank mechanism 30 includes the short lever 32 and the long lever 40, and (b) when the crank mechanism 30 is in its non-P range state, the parking lock device 70 is switched to the unlocked state and the play is taken up by the biasing force F of the compression coil spring 50. In this way, the play is taken up when the parking lock device 70 is switched to the unlocked state, so even if vibrations are input to the shift apparatus 10 from the outside, rattling noise caused by play G of the crank mechanism 30 is suppressed.

### Second Embodiment

FIGS. 4A and 4B are explanatory diagrams of a swing-type slider-crank mechanism 130 (hereinafter referred to simply as “crank mechanism 130”) according to a second embodiment. The crank mechanism 130 has substantially the same configuration as the crank mechanism 30 according to the first embodiment, but differs mainly in that a tension coil spring 56 is disposed instead of the compression coil springs 50 and 52.

FIG. 4A shows a state in which the intersection angle ψ is 0 degrees. FIG. 4B shows a state in which the indicated direction Dᵣ₁ and the indicated direction Dᵣ₂ are both rotated counterclockwise to their maximum extent, and the crank mechanism 130 is in the non-P range state. The crank mechanism 130 is placed in the non-P range state when the rotation angle φ falls within a predetermined angle range including the maximum rotation angle φₘₐₓ.

In the crank mechanism 130, the elongated slot 44 and the pin 36 are engaged so that the absolute value of the intersection angle ψ does not exceed 180 degrees. In this embodiment, the maximum rotation angle θₘₐₓ is 90 degrees. The tension coil spring 56 has, for example, one end 56a coupled to the crank output shaft 48 so as to be relatively rotatable, and the other end 56b coupled to the pin 36 so as to be relatively rotatable. As a result, when the intersection angle ψ exceeds 0 degrees and is smaller than 180 degrees (0<φ<180), the biasing force F of the tension coil spring 56 biases the main body 34 to rotate counterclockwise via the pin 36. The tension coil spring 56 corresponds to the “biasing member” in the present invention.

When the crank mechanism 130 is in the P range state, the biasing force F of the tension coil spring 56 biases the main body 34 to rotate clockwise via the pin 36. In this embodiment, the rotational path of the pin 36 is an arc of the semicircle of the circle C1f on the side opposite to the second axis line C2, i.e., an outer-side path.

According to this embodiment, when the crank mechanism 130 is in the non-P range state, the parking lock device 70 is switched to the unlocked state, and the play is taken up by the biasing force F of the tension coil spring 56. This suppresses the generation of rattling noise in the crank mechanism 130, similar to the first embodiment. Furthermore, compared to the first embodiment, the number of biasing members can be reduced.

### Third Embodiment

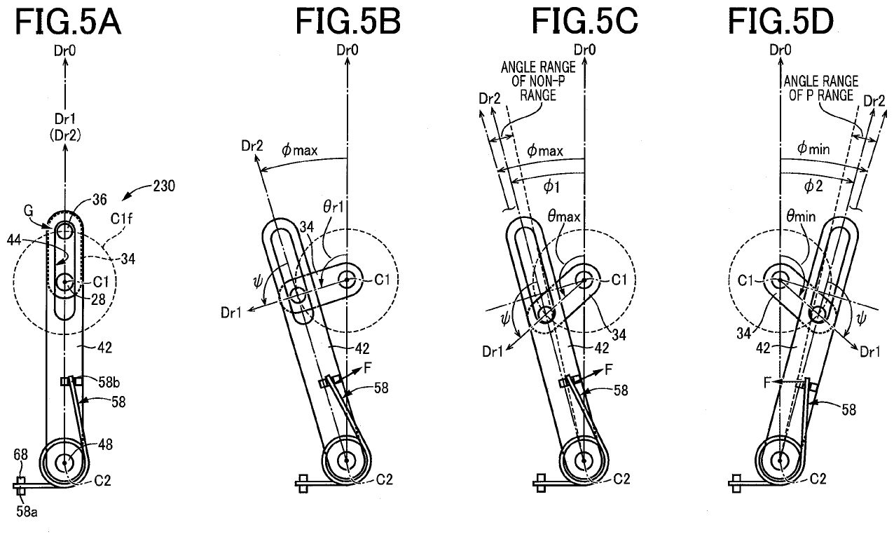

FIGS. 5A to 5D are explanatory diagrams of a swing-type slider-crank mechanism 230 (hereinafter referred to simply as “crank mechanism 230”) according to a third embodiment. The crank mechanism 230 has substantially the same configuration as the crank mechanism 30 according to the first embodiment, but differs mainly in that a torsion coil spring 58 is disposed instead of the compression coil springs 50 and 52.

FIG. 5A shows the state in which the intersection angle ψ is 0 degrees. FIG. 5B shows the state in which the indicated direction Dᵣ₂ has rotated counterclockwise to its maximum, resulting in an intersection angle ψ of 90 degrees, where the rotation angle φ is the maximum rotation angle φₘₐₓ, and the rotation angle θ is the right-angle intersection rotation angle θᵣ₁. FIG. 5C shows the state in which the short lever 32 has further rotated counterclockwise from the state in FIG. 5B, resulting in an intersection angle ψ exceeding 90 degrees. The long lever 40 and the short lever 32 are in the same state as in FIG. 3C. In the crank mechanism 230, the elongated slot 44 and the pin 36 are engaged so that the absolute value of the intersection angle ψ exceeds 90 degrees. Although not shown in FIG. 5, when the short lever 32 rotates clockwise and the intersection angle ψ becomes −90 degrees, the rotation angle φ is the minimum rotation angle φₘᵢₙ, and the rotation angle θ is the right-angle intersection rotation angle θᵣ₂. FIG. 5D shows the state in which the indicated direction Dᵣ₂ has rotated clockwise to its maximum extent, and the short lever 32 has further rotated clockwise, with the long lever 40 and the short lever 32 in the same state as in FIG. 3D.

The crank mechanism 230 includes the torsion coil spring 58. For example, the torsion coil spring 58 has one end 58a coupled to the non-rotating member 68, and the other end 58b coupled between the second axis C2 and the elongated slot 44 in the long lever 40. For example, in FIG. 5A, the torsion coil spring 58 does not bias the long lever 40. In FIGS. 5B and 5C, the torsion coil spring 58 biases the main body 42 of the long lever 40 to rotate clockwise. In FIG. 5D, the torsion coil spring 58 biases the main body 42 to rotate counterclockwise. The torsion coil spring 58 corresponds to the “biasing member” in the present invention.

In FIG. 5C, the same take-up of play as in FIG. 3C is performed. In FIG. 5D, the same take-up of play as in FIG. 3D is performed.

According to this embodiment, when the crank mechanism 230 is in the non-P range state, the parking lock device 70 is switched to the unlocked state, and the partial area is taken up by the biasing force F of the torsion coil spring 58. As a result, similar to the first embodiment, the generation of rattling noise in the crank mechanism 230 is suppressed. Furthermore, compared to the first embodiment, the number of biasing members can be reduced.

### Fourth Embodiment

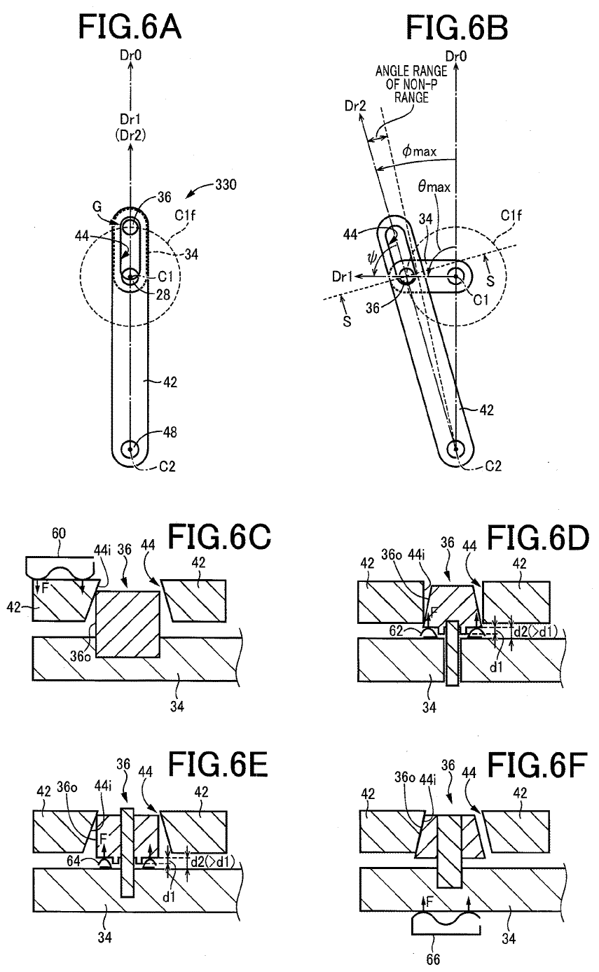

FIGS. 6A to 6F are explanatory diagrams of a swing-type slider-crank mechanism 330 (hereinafter referred to simply as “crank mechanism 330”) according to a fourth embodiment. The crank mechanism 330 has substantially the same configuration as the crank mechanism 130 according to the second embodiment described above, but differs mainly in that at least one of resilient members 60, 62, 64, and 66 is disposed instead of the tension coil spring 56.

FIG. 6A shows the state in which the intersection angle ψ is 0 degrees. FIG. 6B shows the state in which the indicated direction Dᵣ₁ and the indicated direction Dᵣ₂ are both rotated counterclockwise to the maximum extent, and the crank mechanism 330 is in the non-P range state.

In the crank mechanism 330, the elongated slot 44 and the pin 36 are engaged so that the absolute value of the intersection angle ψ does not exceed 180 degrees. FIGS. 6C to 6F are cross-sectional views taken along the line S-S shown in FIG. 6B.

In FIG. 6C, the cylindrical pin 36 extending in the direction of the first axis Cl is fixedly secured to the main body 34. In FIG. 6D, the pin 36 has a cylindrical shaft portion inserted through the main body 34 and movable along the first axis C1, and a cylindrical flange portion fitted to a distal end of the shaft portion on the elongated slot 44 side. In FIG. 6E, the pin 36 has a cylindrical shaft portion extending in the direction of the first axis C1 and fixedly secured to the main body 34, and a cylindrical flange portion inserted into the shaft portion on the elongated slot 44 side and movable in the direction of the first axis C1. In FIG. 6F, the pin 36 has a cylindrical shaft portion extending in the direction of the first axis C1 and fixedly secured to the main body 34, and a cylindrical flange fitted to the distal end of the shaft portion on the elongated slot 44 side. In FIGS. 6D to 6F, the outer peripheral surface 36o is the outer peripheral surface of the flange portion facing the inner wall surface 44i.

In FIGS. 6C to 6F, at least one of the outer peripheral surface 36o and the inner wall surface 44i is tapered. When the outer peripheral surface 36o is tapered, the outer diameter increases as it moves away from the main body 42 in the direction of the first axis Cl. When the inner wall surface 44i is tapered, the inner diameter decreases as it moves away from the main body 34 in the direction of the first axis C1. The maximum outer diameter of the pin 36 in FIGS. 6C to 6F is greater than the minimum inner diameter of the elongated slot 44.

The resilient members 60, 62, 64, and 66 are positioned so that when the crank mechanism 330 is in the non-P range state, a biasing force F acts in the direction of the first axis Cl from one of the outer peripheral surface 36o and the inner wall surface 44i to the other. The resilient members 60, 62, 64, and 66 are, for example, disc springs. The resilient members 60, 62, 64, and 66 include, for example, hemispherical protrusions. The resilient members 60, 62, 64, and 66 each correspond to the “biasing member” in the present invention.

As shown in FIG. 6C, the resilient member 60 biases the tapered inner wall surface 44i so as to press it against the corner of the outer peripheral surface 36o on the main body 42 side.

As shown in FIG. 6D, the resilient member 62 biases the tapered outer peripheral surface 36o of the flange of the pin 36 so as to press it against the corner of the inner wall surface 44i on the main body 34 side. In FIG. 6A, the underside of the pin 36 (=the surface of the flange of the pin 36 on the main body 34 side, the same applies below) is spaced a distance d₁ [m] from the main body 34. In FIG. 6B, the underside of the pin 36 is spaced a distance d₂ [m] from the main body 34. When the state is switched from FIG. 6A to FIG. 6B, the resilient member 62 is inserted between the underside of the pin 36 and the main body 34 such that the spherical surface of the hemispherical protrusion enters through the play of distance d₁.

As shown in FIG. 6E, the resilient member 64 biases the corner of the outer peripheral surface of the flange of the pin 36 on the main body 42 side so as to press it against the tapered inner wall surface 44i. When the state is switched from FIG. 6A to FIG. 6B, the resilient member 64 is inserted between the underside of the pin 36 and the main body 34 such that the spherical surface of the hemispherical protrusion enters through the play of distance d₁.

As shown in FIG. 6F, the resilient member 66 biases the tapered outer peripheral surface of the flange of the pin 36 so as to press it against the tapered inner wall surface 44i.

The biasing force F of these resilient members 60, 62, 64, and 66 in the direction of the first axis C1 suppresses the relative movement between the long lever 40 and the short lever 32 by friction. The biasing force F of the motor 26 serves to suppress the relative movement between the short lever 32 and the long lever 40, and corresponds to the “predetermined take-up of play” in the present invention. The magnitude of the friction force is set so that the motor 26 can rotate the short lever 32 against the friction force, and so that external vibrations do not cause relative movement between the long lever 40 and the short lever 32. Although not described herein, similarly, when the crank mechanism 330 is in the P range state, the predetermined take-up of play is performed to suppress relative movement between the short lever 32 and the long lever 40.

According to this embodiment, when the crank mechanism 330 is in the non-P range state, the parking lock device 70 is switched to the unlocked state, and the relative movement between the short lever 32 and the long lever 40 is suppressed by the biasing force F from at least one of the resilient members 60, 62, 64, and 66. In consequence, the generation of rattling noise in the crank mechanism 330 is suppressed, as in the second embodiment.

### Fifth Embodiment

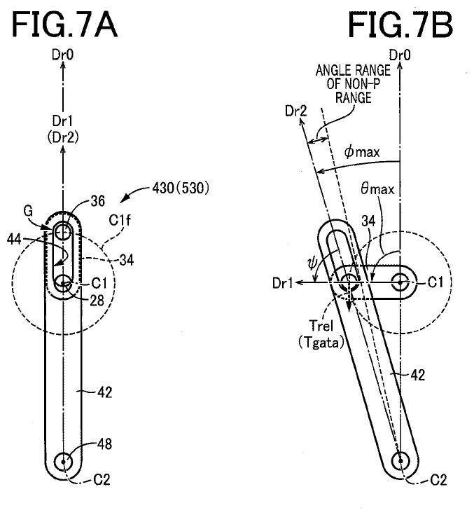

FIGS. 7A and 7B are explanatory diagrams of a swing-type slider-crank mechanism 430 (hereinafter referred to simply as “crank mechanism 430”) according to a fifth embodiment. Note that the reference numerals in parentheses in FIG. 7 refer to those of a sixth embodiment, which will be described later. The crank mechanism 430 has substantially the same configuration as the crank mechanism 130 according to the second embodiment, but differs mainly in that it does not include the tension coil spring 56.

FIG. 7A shows the state in which the intersection angle ψ is 0 degrees, and FIG. 7B shows the state in which the indicated direction Dᵣ₁ and the indicated direction Dᵣ₂ are both rotated counterclockwise to the maximum extent, and the crank mechanism 430 is in the non-P range state.

In the crank mechanism 430, the elongated slot 44 and the pin 36 are engaged so that the absolute value of the intersection angle ψ does not exceed 180 degrees. Preferably, the maximum absolute value of the intersection angle ψ of the crank mechanism 530 is approx. 90 degrees.

When the crank mechanism 430 is switched to the non-P range state, the motor 26 rotates the short lever 32 counterclockwise until the crank mechanism 430 reaches the non-P range state. Preferably, the rotation of the motor 26 is stopped slightly before the rotation angle φ reaches the maximum rotation angle φₘₐₓ, and the motor 26 is brought into the non-driven state. At this time, the rotation of the motor 26 is stopped at a position where the play is taken up by the reluctance torque Tᵣₑₗ. When motor 6 is deactivated, the play is taken up by the reluctance torque Tᵣₑₗ of the motor 26. The reluctance torque Tᵣₑₗ is set to a value that allows the play to be taken up.

According to this embodiment, (a) when the rotation angle θ is the maximum rotation angle θₘₐₓ, the intersection angle ψ is less than 180 degrees, and (b) when the crank mechanism 430 is in the non-P range state, the parking lock device 70 is switched to the unlocked state and the play is taken up by the biasing force F of the reluctance torque Tᵣₑₗ. This makes it possible to suppress the generation of rattling noise in the crank mechanism 430 without disposing any biasing member.

### Sixth Embodiment

A swing-type slider crank mechanism 530 (hereinafter referred to simply as “crank mechanism 530”) according to a sixth embodiment has substantially the same configuration as the crank mechanism 430 according to the fifth embodiment, but differs mainly in that when the crank mechanism 530 is in the non-P range state, a play-take-up torque T_{gata} [N·m], which is a torque that takes up the play G, is output from the motor 26.

When the crank mechanism 530 is switched to the non-P range state, a play-take-up torque T_{gata} is output from the motor 26, and the play is taken up by the play-take-up torque T_{gata}. The “play-take-up torque T_{gata}” is obtained by converting the torque required to take up the play G in order to suppress rattling noise into a torque value of the motor 26, and is a predetermined torque that is determined in advance through experimentation or design. The play-take-up torque T_{gata} corresponds to the “predetermined torque” in the present invention.

The play-take-up torque T_{gata} may be output all the time when the crank mechanism 530 is in the non-P range state, or may be output only when a predetermined condition is met under which it is assumed that a rattling noise may be generated due to external vibrations. The predetermined condition is, for example, at least one of: that the vehicle speed V is equal to or greater than a predetermined vehicle speed value V__{jdg}; that the vehicle acceleration α (e.g., (Aₓ²+A_{y}²)^{1/2}) is equal to or greater than a predetermined acceleration value α__{jdg}; and that the torque change ΔTᵣ[N·m/s], which is the change per unit time of the drive torque Tᵣ[N·m], is equal to or greater than a predetermined change value ΔT_{r_jdg}. A demanded drive torque T_{rdem} [N·m] as a drive torque Tᵣ required for the vehicle 100 is calculated by applying an actual accelerator opening θ_{ace} and an actual vehicle speed V to a relationship among a predetermined accelerator opening θ_{ace}, a predetermined vehicle speed V, and the demanded drive torque T_{rdem}. The drive torque Tᵣ of the vehicle 100 is determined based on the required drive torque T_{rdem}. The output torque of the driving power source is controlled to be equal to the drive torque Tᵣ of the vehicle 100. The predetermined vehicle speed value V__{jdg}, the predetermined acceleration value α__{jdg}, and the predetermined change amount value ΔT_{r_jdg} are predetermined judgment values that are determined in advance experimentally or by design, and at which external vibrations may cause rattling noise in the crank mechanism 530.

According to this embodiment, (a) when the rotation angle θ is the maximum rotation angle θₘₐₓ, the intersection angle ψ is less than 180 degrees, and (b) when the crank mechanism 530 is in the non-P range state, the parking lock device 70 is switched to the unlocked state and the play is taken up by outputting a play-take-up torque T_{gata} from the motor 26. This suppresses the generation of rattling noise in the crank mechanism 530 without disposing a biasing member.

It should be noted that the above are merely embodiments, and the present invention can be embodied in various forms with various modifications and improvements based on the knowledge of those skilled in the art without departing from the spirit of the present invention.

The resilient members 60, 62, 64, and 66 in the fourth embodiment are merely examples, and the present invention is not limited thereto. In essence, it is sufficient that the resilient members be disposed at a position where, when the crank mechanism 330 is in the non-P-range state, a biasing force F acts in the direction of the first-axis C1 from one of the outer peripheral surface 36o and the inner wall surface 44i toward the other.

In the first to fourth embodiments described above, the crank mechanisms 30, 130, 230, and 330 may be configured so that the short lever 32 can rotate 360 degrees, as long as the rotation of the short lever 32 is maintained stopped by the reluctance torque Tᵣₑₗ or the frictional force of the resilient members 60, 62, 64, and 66 when the crank mechanisms 30, 130, 230, and 330 are in the non-P range state. For example, when the short lever 32 is configured so that it can rotate 360 degrees and the rotational path of the pin 36 is an outer-side path, the reduction ratio of the crank mechanisms 30, 130, 230, and 330 is increased and the ratio of the output torque of the crank output shaft 48 to the output torque of the motor 26 is reduced, as compared to when it is not. For example, when the indicated direction Dᵣ₁ is the same as the reference direction Dᵣ₀, the reduction ratio of the crank mechanisms 30, 130, 230, and 330 is increased by a factor of {(L₁+L₂)/L₁−L₂)} compared to when the indicated direction Dᵣ₁ is opposite to the reference direction Dᵣ₀. That is, the ratio of the output torque of the crank output shaft 48 to the output torque of the motor 26 is reduced by a factor of {(L₁−L₂)/(L₁+L₂)}.

In the above first, second, third, fourth and sixth embodiments, the intersection angle ψ is less than 180 degrees. In such embodiments, the motor 26 may not generate reluctance torque Tᵣₑₗ in the non-driven state.

Although in the above first to sixth embodiments, the predetermined take-up of play is performed even when the crank mechanisms 30, 130, 230, 330, 430, and 530 (hereinafter referred to simply as the “crank mechanism 30, etc.”) are in the P range state, it may be possible to perform the predetermined take-up of play, for example, only when the crank mechanism 30, etc. are in the non-P range state. This is because when the crank mechanism 30, etc. are in the P range state, there is a lower risk of rattling noise being generated by external vibrations compared to when the crank mechanism 30, etc. are in the non-P range state.

In the above first to sixth embodiments, a speed reducer separate from the crank mechanism 30, etc. may be disposed in the power transmission passage between the motor 26 and the crank mechanism 30, etc. or in the power transmission passage between the crank mechanism 30, etc. and the parking lock device 70.

### NOMENCLATURE OF ELEMENTS

10: shift apparatus
26: motor
30, 130, 230, 330, 430, 530: swing-type slider-crank mechanism
32: short lever
40: long lever
50: compression coil spring (biasing member)
56: tension coil spring
58: torsion coil spring (biasing member)
60, 62, 64, 66: resilient members (biasing member)
70: parking lock device
Dᵣ₁: indicated direction (predetermined indicated direction of short lever)
Dᵣ₂: indicated direction (predetermined indicated direction of long lever)
Tᵣₑₗ: reluctance torque
T_{gata}: play-take-up torque (predetermined torque)
ψ: intersection angle

What is claimed is:

1. A shift apparatus comprising a motor and a swing-type slider crank mechanism that decelerates rotation of the motor, the shift apparatus selectively switching an operating state of a parking lock device between a locked state and an unlocked state, wherein
the swing-type slider crank mechanism comprises a short lever and a long lever, and wherein
when the swing-type slider crank mechanism is in a predetermined state, the operating state of the parking lock device is switched to the unlocked state, and a predetermined take-up of play is performed to suppress relative movement between the short lever and the long lever in order to suppress rattling noise between the short lever and the long lever.

2. The shift apparatus according to claim 1, wherein
the predetermined take-up of play is achieved by a biasing force of a biasing member.

3. The shift apparatus according to claim 2, wherein
when the short lever is rotated to a maximum extent thereof, an intersection angle between a predetermined indicated direction of the short lever and a predetermined indicated direction of the long lever is greater than 90 degrees and less than 180 degrees.

4. The shift apparatus according to claim 1, wherein
when the short lever is rotated to a maximum extent thereof, an intersection angle between a predetermined indicated direction of the short lever and a predetermined indicated direction of the long lever is less than 180 degrees, wherein
the motor generates a reluctance torque in a non-driven state, and wherein
rotation of the motor is stopped at a position where the predetermined take-up of play is performed by the reluctance torque.

5. The shift apparatus according to claim 1, wherein
when the short lever is rotated to a maximum extent thereof, an intersection angle between a predetermined indicated direction of the short lever and a predetermined indicated direction of the long lever is less than 180 degrees, and wherein
a predetermined torque is output from the motor to perform the predetermined take-up of play.
